(19) United States
(12) Patent Application Publication
(10) Pub. No.: US 2017/0193306 A1
(43) Pub. Date: Jul. 6, 2017

(54) Wearable Camera Activated Security Accessory

(71) Applicant: Michael Robil, Tampa, FL (US)

(72) Inventor: Michael Robil, Tampa, FL (US)

(21) Appl. No.: 14/987,720

(22) Filed: Jan. 4, 2016

(51) Int. Cl. G06K 9/00; H04N 5/232; G01S 19/01; H04W 4/02; H04M 1/725; G08B 21/02; H04N 5/225; G06F 3/16

(52) U.S. Cl. CPC G06K 9/00771; H04N 5/2257; G06K 9/00255; G06K 9/00295; H04N 5/23219; G06F 3/16; H04W 4/025; H04M 1/7253; H04M 1/72569; H04M 1/72572; G08B 21/0277; G01S 19/01; H04W 88/06

(57) ABSTRACT

A wearable camera activated security accessory including a motion sensor activated camera. The motion sensor is activated when motion takes place proximal to a wearer of the accessory. As a result, a camera is activated in response to the activation of the motion sensor. Facial information of a person causing the activation of the motion sensor is then acquired and recorded. The facial information is acquired using facial recognition techniques. Acquired facial information is then sent to a remote server that is accessible by both a mobile phone application and/or authorities.

### FIELD OF THE INVENTION

The present invention relates to a wireless security system and apparatus. More specifically, the present invention relates to an intelligent wearable device that assumes the form of a clothing accessory, which includes

### BACKGROUND OF THE INVENTION

One problem that is facing parents is kidnappings of children. Kidnappings and abductions have been rising recently. The numbers of the children kidnapped or abducted daily are staggering. Recent social experiments have been showing that a child might be kidnapped within seconds. The child might not have the means or the time to avoid such situations. Simply showing a child a puppy, a pet, or any means that is of interest to that child can draw the attention of child. When this happens, the child is in great danger, since the child can be easily convinced to walk away with a predator.

Another problem facing parents is the abuse of a child. Parents might leave their child at home with a baby sitter or a care giver; they can also leave their children at school or at any other establishment that temporarily looks after children. Recent popular videos have shocked the public with footage of children abuse. A common issue in these videos is a care giver hitting a child at home or at school. In these cases, cameras have accidently caught the incident because of the misfortune of the abuser. If the cameras where not accidently recording from a certain angle at a given time, those particular incidents would have never been known to the public. The actual number of child abuse can never be predicted, since video cameras cannot cover every inch of an establishment or a home. In most cases, an abuser or a kidnapper can get away with the incident.

Therefore, a demanding immediate need exists for a device that can dramatically reduce such incidents. The embodiments of the current invention are directed to a wearable device assuming the shape of a clothing accessory that is equipped with a camera capable of facial recognition that is activated by a motion sensor; the motion sensor is activated when motion takes place proximal to the wearer of such device.

### DISCUSSION OF THE RELATED ART

The embodiments of the present invention relate to the field of security devices meant to protect children and even adults from possible danger. Specifically, the embodiments of the present invention relate to security devices that produce an indication when a possible danger event takes occurs.

One example of such devices is a device that produces a visual and/or a sound notification to a parent when a child moves outside a security distance. In this case, a security system is configured to emit the visual and/or sound notification to a parent if the child exceeds a predetermined distance. However, this system is only intended for normal circumstances, and does not take into account the possible danger of an experienced kidnapper. An experienced kidnapper can operate within the predetermined distance, and become successful in kidnapping the child. Further, even if the alarm is successful in driving the kidnapper away, the system does not recognize the kidnapper. Also, the child might be too young to recognize the kidnapper.

Another example of such devices is a GPS enabled device. In this case, the child wears an accessory that is GPS enabled. This device provides its own position at all times, thus providing the position of the wearer. Again, this approach does not take into account the possibility of a dangerous and experienced kidnapper. This system does not recognize the kidnapper, since it only provides its current position. Further, since it is only intended for normal circumstances, such as a child straying away, or getting lost, the shape it assumes is very obvious to a kidnapper. The kidnapper can easily throw it away, or even harm the wearer in order to throw the device away.

Thus, design of a device that is capable of being intelligently hidden from the eyes of a kidnapper as well as automatically identifying facial information of a kidnapper and the device's own location is an important issue in the related security device industry.

### SUMMARY OF THE INVENTION

Therefore, the object of the present invention is to provide an intelligent wearable device that assumes the form of a clothing accessory which eliminates the drawbacks of the prior art.

According to one aspect of the present invention, there is provided a wearable device activating a camera to capture images that are used to perform facial recognition of a person proximal to the wearer. The camera is activated in response to a motion sensor that senses the presence of an object moving proximal to the wearer. Facial information is then recorded and sent to a remote server that logs such information. The facial information can then be accessed by authorized personnel. The wearable device is connected to a mobile phone application through Bluetooth™ and at least one of a cellular network and a Wireless Local Access Network in order to provide GPS location of the wearable device to the mobile phone application.

According to another aspect of the present invention, there is provided a wearable camera activated security accessory comprising, a camera module capable of capturing pictures that are used to perform facial recognition, a motion sensor, a Global Positioning System (GPS) transceiver, a processor, a memory, a wireless module, a power supply, and material that allows the camera to capture clear pictures, but does not allow the camera to be seen.

According to another aspect of the present invention, there is provided a wearable camera activated security accessory comprising, a camera module capable of capturing pictures that are used to perform facial recognition, a motion sensor, a Global Positioning System (GPS) transceiver, a processor, a memory, a wireless module, a power supply, a panic button and material that allows the camera to capture clear images, but does not allow the camera to be seen.

According to another aspect of the present invention, there is provided a system comprising, a mobile phone having thereon a security application capable of receiving and accessing information transmitted from a wearable camera activated security accessory, a wearable camera activated security accessory capable of capturing images used to perform facial recognition, and a remote server that is capable of storing information transmitted from the wearable camera activated security accessory, wherein the information is accessible by authorized personnel.

According to another aspect of the present invention, there is provided a method comprising: sending current location of a wearable accessory to a mobile phone application running on a user's mobile phone; checking whether a motion sensor of a wearable accessory is active; in response to the motion sensor being active, activating a camera of the wearable accessory to capture images, wherein the images are used to perform facial recognition of a moving object proximal to a wearer of the accessory; sending information related to a camera activation incident to a remote server; storing said information by the sever; and accessing said information by authorized personnel.

According to another aspect of the present invention, there is provided a method comprising: sending current location of a wearable accessory to a mobile phone application running on a user's mobile phone; checking whether a motion sensor of a wearable accessory is active; in response to the motion sensor being active, activating a camera of the wearable accessory to capture images, wherein the images are used to perform facial recognition of a moving object proximal to a wearer of the accessory; sending information related to a camera activation incident to a remote server; storing said information by the sever; accessing said information by authorized personnel, and manipulating said information by authorized personnel.

According to another aspect of the current invention, there is provided a non-transitory computer readable medium, having stored there on a computer program having a plurality of code sections executable by a processor, for causing a wearable device to perform the operations of the method described above.

### BRIEF DESCRIPTION OF THE DRAWINGS

FIG. 1 is a schematic diagram of a system according to an embodiment of the present invention.

FIG. 2(a) is a functional block diagram of a wearable camera activated security accessory according to a first embodiment of the present invention.

FIG. 2(b) is a functional block diagram of a wireless module according to an embodiment of the present invention.

FIG. 3 is a functional block diagram of a wearable camera activated security accessory according to a second embodiment of the present invention.

FIG. 4 is a flow chart of capturing facial images of a person within proximity of a wearable camera activated security accessory according to the first embodiment of the present invention.

FIG. 5 is a flow chart of capturing facial images of a person within proximity of a wearable camera activated security accessory, based on an activation of a panic button according to the second embodiment of the present invention.

FIG. 6 is a schematic diagram of a system according to an embodiment of the present invention, wherein a child is wearing a wearable camera activated security accessory.

FIG. 7(a) is a flow chart of changing a setting of the security accessory from a default security mode to a leisure mode.

FIG. 7(b) is a flow chart of changing a setting of the security accessory from a default leisure setting to a security setting.

FIG. 8 is a flow chart of overwriting a default leisure setting to change it to a security setting remotely.

### DETAILED DESCRIPTION

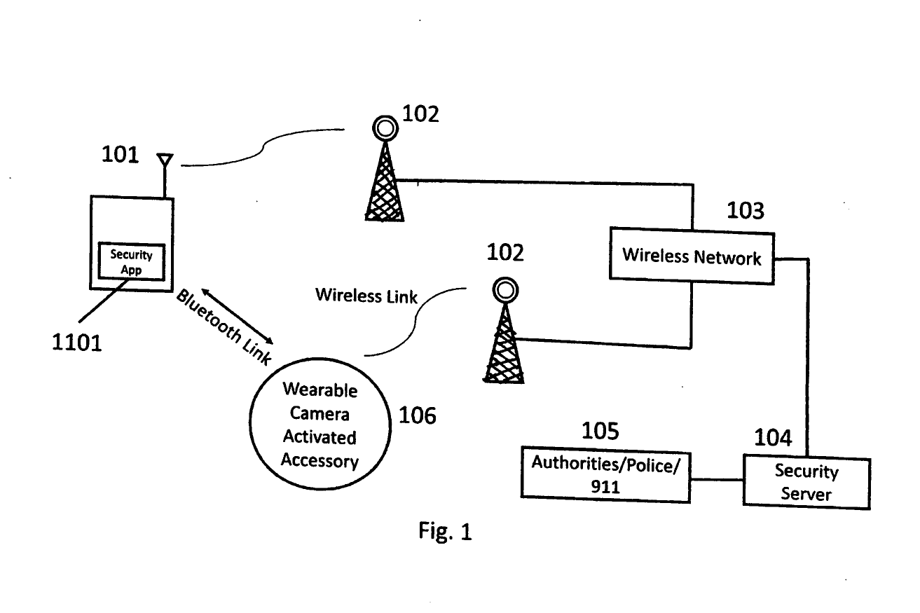

Please refer to FIG. 1. FIG. 1 is a schematic diagram of a system according to an embodiment of the present invention. The system of FIG. 1 includes a mobile device 101, including a security application 1101, base stations 102 for cellular connection and/or WLAN connection, a wireless network 103, a security server 104, an authority agency 105, and a wearable camera activated accessory 106. The wearable camera activated device is connected to a cellular network and/or a WLAN network via a wireless link, and connected to a mobile device of a user via a Bluetooth link. Generally, when a wearer encounters motion within his or her vicinity, a camera within the wearable accessory is activated in response to the activation of a motion sensor that is also located within the wearable accessory. Therefore, when the motion sensor of the wearable accessory senses a motion proximal to the wearer of the accessory, the camera module is then activated, causing the capturing of images of a person or an object that is within proximity, such a proximity is a distance that ranges from 0-3 feet. The images captured are then used to recognize a face of the person near the wear. Those images are then immediately sent, along with position and/or time information to a remote security server 104 through a wireless network 103.

The remote security server 104 keeps a log of the most recent images, and information sent with the captured images in order to recognize a person that was in proximity of the wearer, as well as location and/or time an image was captured. A user of a mobile device 101 can then access and edit or delete such log via a security application 1101 running on the user's mobile device. The user of a mobile device 101 might be a parent, a relative, or a caregiver. Further, the wearable camera activated security accessory continuously sends location information via the Bluetooth and/or wireless network to the security application 1101 running on the mobile device 101.

Considering a case of abduction, a predator approaches the child, thus being in the vicinity of the motion sensor that resides within the wearable accessory, which causes the motion sensor to be activated. The motion sensor activates a camera to capture images in order to perform facial recognition operations to identify the predator. The security application running on the user's mobile device receives the latest information about the position of the wearable accessory. Also, the remote server now contains at least one of a position of the wearable accessory, facial information of the predator, and the time of the offense. When the user calls the authorities, or 911. Authorities can immediately access the information on the server, and thus, saving valuable time in retrieving the accessory wearer.

Further, the predator is unlikely to notice the wearable accessory since it assumes the form of a clothing accessory. This drastically increases the possibility that the predator would not throw the wearable accessory away or harm the wearer in the process.

The wearable camera activated accessory also comprises chemically treated glass or any other material that allows the camera inside the accessory to capture clear images without being seen from a close distance. A person skilled in the art would also recognize that chemically treated glass allows water to slide, in order to capture clear images.

Moreover, a person skilled in the art would expect that the wireless network 103 can be cellular or WLAN or a combination of both. Also, the position of the wearable accessory can be obtained using GPS, cellular networks, or any other means of position determination of a mobile device.

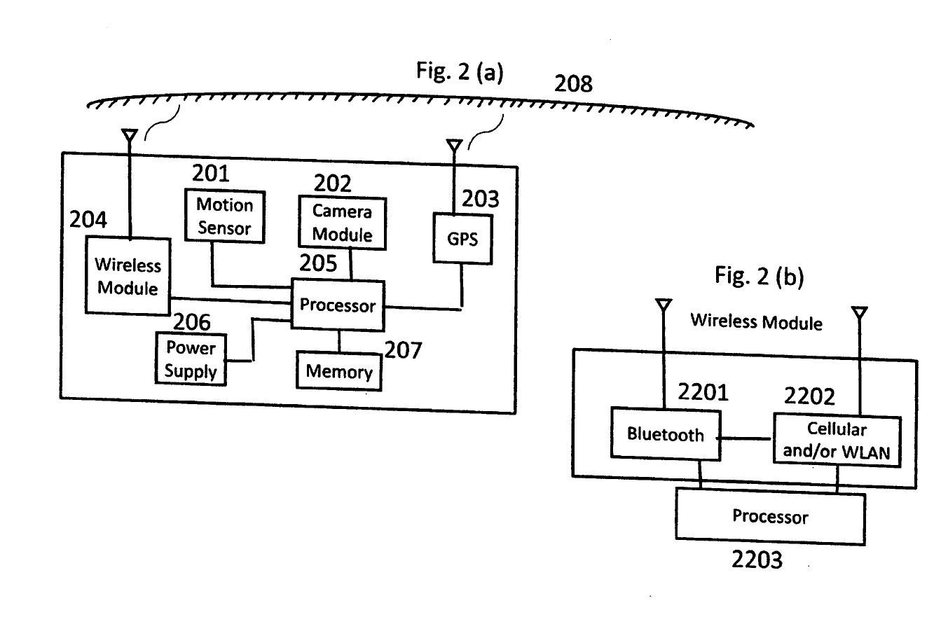

Please refer to FIG. 2(a). FIG. 2(a) is a functional block diagram of a wearable camera activated security accessory according to a first embodiment of the present invention. The wearable camera activated security accessory comprises a motion sensor 201, a camera module 202, a GPS transceiver 203, a wireless module 204, a processor 205, a power supply 206, a memory 207, and chemically treated material that allows said camera to capture images of a face of said person without being seen by said person proximal to said accessory 208. When the motion sensor of the wearable accessory senses a motion proximal to the wearer of the accessory, the camera module is then activated, causing the capturing of images of a person or an object that is within proximity. The images are then stored in a memory of the device in order to be transmitted through the wireless network. The images captured are then used to recognize a face of the person near the wear. Those images are then immediately sent, along with position and/or time information to a remote security server 104 through a wireless network 103.

As would be expected by a person skilled in the art, the configuration shown in FIG. 2(a) is exemplary and is not intended to limit the configuration of the wearable accessory. While the detailed description will provide those skilled in the art with a convenient roadmap for implementing various embodiments of the invention, it should be appreciated that FIG. 2(a) is not intended to limit the scope, applicability, or configuration of the invention in anyway.

Please refer to FIG. 2(b). FIG. 2(b) is a functional block diagram of a wireless module according to an embodiment of the present invention. The wireless module of FIG. 2(b) comprises Bluetooth block 2201, cellular and/or WLAN block 2202, and processor 2203. FIG. 2 (b) shows the wearable camera activated security accessory is capable of connecting to at least one of Bluetooth, cellular network, WLAN network, or a combination thereof through the wireless module.

As would be expected by a person skilled in the art, the configuration shown in FIG. 2(b) is exemplary and is not intended to limit the configuration of the wearable accessory. While the detailed description will provide those skilled in the art with a convenient roadmap for implementing various embodiments of the invention, it should be appreciated that FIG. 2(b) is not intended to limit the scope, applicability, or configuration of the invention in anyway.

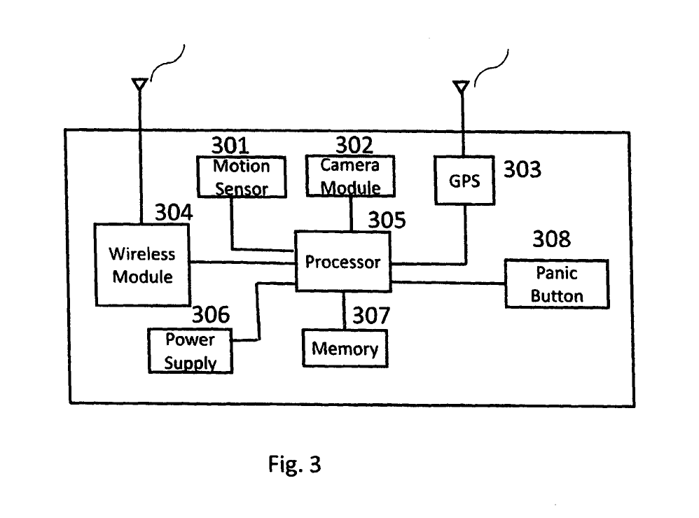

Please refer to FIG. 3. FIG. 3 is a functional block diagram of a wearable camera activated security accessory according to a second embodiment of the present invention. The wearable camera activated security accessory comprises a motion sensor 301, a camera module 302, a GPS transceiver 303, a wireless module 304, a processor 305, a power supply 306, a memory 307, and a panic button 308. When the motion sensor of the wearable accessory senses a motion proximal to the wearer of the accessory, the camera module is then activated, causing the capturing of images of a person or an object that is within proximity. The images are then stored in a memory of the device in order to be transmitted through the wireless network. The images captured are then used to recognize a face of the person near the wear. Those images are then immediately sent, along with position and/or time information to a remote security server 104 through a wireless network 103. Further, if the motion sensor is not activated and a panic button is pressed for any reason, the camera module is then activated, causing the capturing of images of a person or an object that is within proximity. The images are then stored in a memory of the device in order to be transmitted through the wireless network. The images captured are then used to recognize a face of the person near the wear. Those images are then immediately sent, along with position and/or time information to a remote security server 104 through a wireless network 103

As would be expected by a person skilled in the art, the configuration shown in FIG. 3 is exemplary and is not intended to limit the configuration of the wearable accessory. While the detailed description will provide those skilled in the art with a convenient roadmap for implementing various embodiments of the invention, it should be appreciated that FIG. 3 is not intended to limit the scope, applicability, or configuration of the invention in anyway.

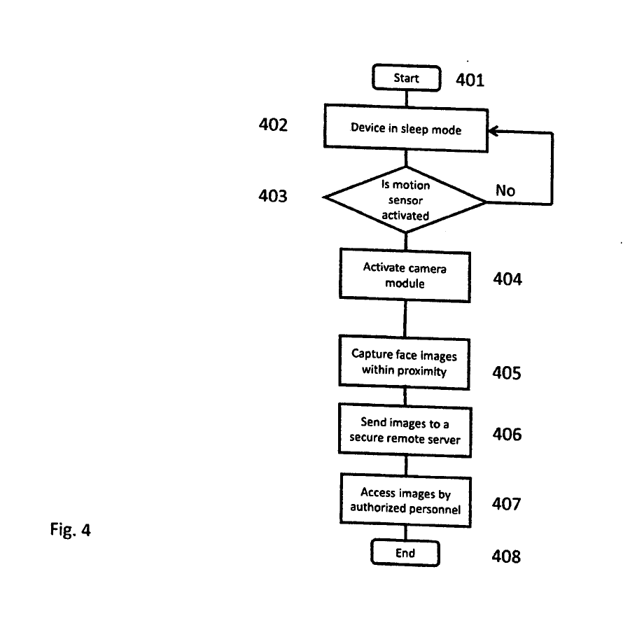

Please refer to FIG. 4. FIG. 4 is a flow chart of capturing facial images of a person within proximity of a wearable camera activated security accessory according to the first embodiment of the present invention. The process starts with step 401, the wearable accessory is in sleep mode in step 402. In step 403 a decision block determines whether the wearable accessory stays in sleep mode or a camera module is activated. When the result of the decision block is that the motion sensor is not activated, due to lack of motion proximal to the motion sensor, the process proceeds to step 402 where the wearable accessory is in a sleep mode. When the result of the decision block is that a motion was detected, the process proceeds to step 404 where the camera module is activated. In step 405, a camera within the wearable accessory is activated in response to the activation of a motion sensor that is also located within the wearable accessory. Therefore, when the motion sensor of the wearable accessory senses a motion proximal to the wearer of the accessory, the camera module is then activated, causing the capturing of images of a person or an object that is within proximity. The images captured are then used to recognize a face of the person near the wear. In step 406, images are then immediately sent, along with position and/or time information to a secure remote security server 104 through a wireless network 103. The remote security server 104 keeps a log of the most recent images, and information sent with the captured images in order to recognize a person that was in proximity of the wearer, as well as location and/or time an image was captured. In step 407, a user of a mobile device 101 can then access and edit or delete such log via a security application 1101 running on the user's mobile device. In step 408, the process ends.

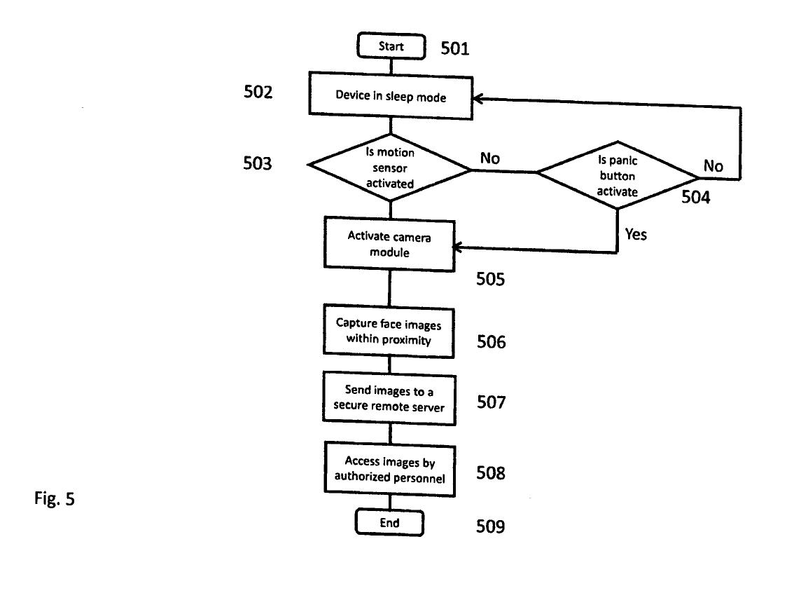

Please refer to FIG. 5. FIG. 5 is a flow chart of capturing facial images of a person within proximity of a wearable camera activated security accessory, based on an activation of a panic button according to the second embodiment of the present invention. The process starts with step 501, the wearable accessory is in sleep mode in step 502. In step 503 a decision block determines whether the wearable accessory stays in sleep mode or to proceed to the next decision block 504. In step 504, the decision block determines whether the wearable accessory stays in sleep mode or a camera module is activated. When the result of the decision block 503 is that the motion sensor is not activated, due to lack of motion proximal to the motion sensor, the process proceeds to step 504 where the decision block determines whether the wearable accessory stays in sleep mode or a camera module is activated. When the result of the decision block 504 is that a motion was detected, the process then proceeds to step 505. When the result of the decision block 503 is that a motion was detected, the process proceeds to step 505 where the camera module is activated. In step 505, a camera within the wearable accessory is activated in response to the activation of a motion sensor that is also located within the wearable accessory. Therefore, when the motion sensor of the wearable accessory senses a motion proximal to the wearer of the accessory, the camera module is then activated, causing the capturing of images of a person or an object that is within proximity in step 506. The images captured are then used to recognize a face of the person near the wear. In step 507, images are then immediately sent, along with position and/or time information to a secure remote security server 104 through a wireless network 103. The remote security server 104 keeps a log of the most recent images, and information sent with the captured images in order to recognize a person that was in proximity of the wearer, as well as location and/or time an image was captured. In step 508, a user of a mobile device 101 can then access and edit or delete such log via a security application 1101 running on the user's mobile device. In step 509, the process ends.

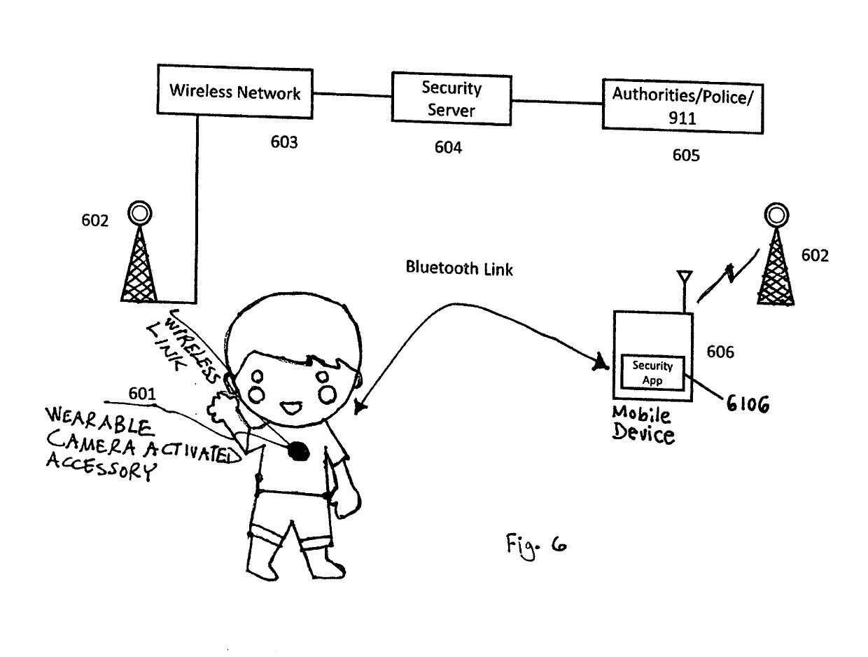

Please refer to FIG. 6. FIG. 6 is a schematic diagram of a system according to an embodiment of the present invention, wherein a child is wearing a wearable camera activated security accessory. The system of FIG. 6 includes a mobile device 606, including a security application 6106, base stations 602 for cellular connection and/or WLAN connection, a wireless network 603, a security server 604, an authority agency 605, and a wearable camera activated accessory 601. The wearable camera activated device is connected to a cellular network and/or a WLAN network via a wireless link, and connected to a mobile device of a user via a Bluetooth link. Generally, when a wearer encounters motion within his or her vicinity, a camera within the wearable accessory is activated in response to the activation of a motion sensor that is also located within the wearable accessory. Therefore, when the motion sensor of the wearable accessory senses a motion proximal to the wearer of the accessory, the camera module is then activated, causing the capturing of images of a person or an object that is within proximity. The images captured are then used to recognize a face of the person near the wear. Those images are then immediately sent, along with position and/or time information to a remote security server 604 through a wireless network 603.

The remote security server 604 keeps a log of the most recent images, and information sent with the captured images in order to recognize a person that was in proximity of the wearer, as well as location and/or time an image was captured. A user of a mobile device 606 can then access and edit or delete such log via a security application 6106 running on the user's mobile device. The user of a mobile device 606 might be a parent, a relative, or a caregiver. Further, the wearable camera activated security accessory continuously sends location information via the Bluetooth and/or wireless network to the security application 6106 running on the mobile device 606.

While the detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

The motion sensor can be activated by different methods. The motion sensor can be activated in response to a panic button being pressed by the wearer of said security accessory. The motion sensor is activated in response to a tap by a wearer or in response to a wearer's voice recognized by a voice recognition module. The motion sensor can be also activated in response to at least one pre-recorded phrase or at least one pre-recorded word recognized by a phrase recognition module. The wearable security accessory can be configured to include a phrase recognition module, wherein the security accessory recognizes a word or a combination of words that form a phrase. Such word or a combination of words, would in turn activate the motion sensor.

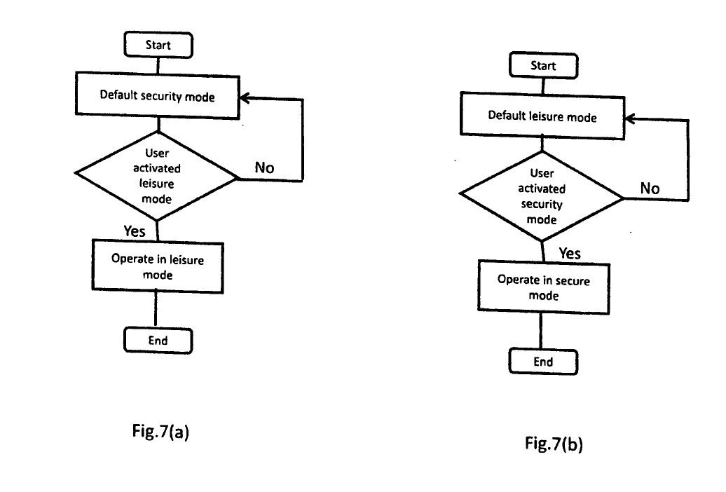

Please refer to FIG. 7(a) is a flow chart of changing a setting of the security accessory from a default security mode to a leisure mode. In one mode of operation of the wearable security accessory, the security accessory might have a default setting that is a security mode. In the security mode, the device operates in accordance with the security operations discussed in the first and second embodiments as presented herein. The wearer however, might want to use the wearable security accessory for leisure purposes. In this leisure mode, the security features are turned off. For example, the wearer might place the device in leisure mode in order to take pictures by the security accessory. When the wearable security accessory is in a security mode, the wearer can easily switch to a leisure mode in which the wearer can take pictures according to an input from the wearer.

Please refer to FIG. 7(b) is a flow chart of changing a setting of the security accessory from a default leisure mode to a security mode. In another mode of operation, the wearable security device's default mode is a leisure mode. However, the device can be easily switched to a security mode when an emergency occurs. When an emergency occurs, the wearable security device would be easily triggered to switch to a security mode by a tap, a person approaching, in response to a wearer's recognized voice or by at least one pre-recorded phrase or at least one pre-recorded word recognized by a phrase recognition module.

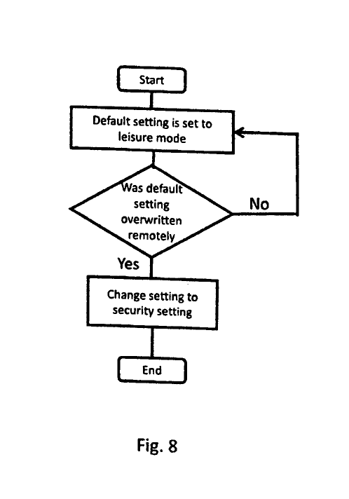

Please refer to FIG. 8, FIG. 8 is a flow chart of overwriting a default leisure setting to change it to a security setting remotely. In another mode of operation of the wearable security accessory, a remote authorized user can overwrite the default setting of the wearable security accessory. For example, a parent might want to overwrite the current default leisure mode of their child's wearable security accessory and change the setting into a security mode.

1. A wearable camera activated security accessory, comprising:
(a) a motion sensor configured to sense motion of a person proximal to a wearer of the accessory;
(b) a camera module configured to capture images of a face of the person proximal to the wearer of said accessory, in order to store facial information;
(c) a Global Positioning System (GPS) module configured to obtain location information of said accessory;
(d) a wireless module comprising:
(i) a Bluetooth block configured to connect said accessory to a mobile phone; and
(ii) a cellular block configured to connect said accessory to a cellular network.

2. The wearable camera activated security accessory according to claim 1, wherein said security accessory is connected to a mobile phone via a Bluetooth connection.

3. The wearable camera activated security accessory according to claim 1, wherein said security accessory is connected to a cellular network via a wireless link.

4. The wearable camera activated security accessory according to claim 1, wherein the motion sensor is activated in response to a panic button being pressed by the wearer of said security accessory.

5. The wearable camera activated security accessory according to claim 1, wherein the motion sensor is activated in response to a tap by a wearer.

6. The wearable camera activated security accessory according to claim 1, wherein the motion sensor is activated in response to a wearer's voice recognized by a voice recognition module.

7. The wearable camera activated security accessory according to claim 1, wherein the motion sensor is activated in response to at least one pre-recorded phrase or at least one pre-recorded word recognized by a phrase recognition module.

8. A security system, comprising:
a wearable camera activated security device assuming the shape of a wearable accessory, wherein said wearable accessory further comprises:
(a) a motion sensor configured to sense motion of a person proximal to a wearer of the accessory;
(b) a camera module configured to capture images of a face of the person proximal to the wearer of said accessory, in order to store facial information;
(c) a Global Positioning System (GPS) module configured to obtain location information of said accessory;
(d) a wireless module comprising, a cellular block configured to connect said accessory to a cellular network.

9. The wearable camera activated security accessory according to claim 8, wherein said security accessory is connected to a mobile phone via a Bluetooth connection.

10. The wearable camera activated security accessory according to claim 8, wherein said security accessory is connected to a cellular network via a wireless link.

11. The wearable camera activated security accessory according to claim 8, wherein the motion sensor is activated in response to a panic button being pressed by the wearer of said security accessory.

12. The wearable camera activated security accessory according to claim 8, wherein the motion sensor is activated in response to a tap by a wearer.

13. The wearable camera activated security accessory according to claim 8, wherein the motion sensor is activated in response to a wearer's voice recognized by a voice recognition module.

14. The wearable camera activated security accessory according to claim 8, wherein the motion sensor is activated in response to at least one pre-recorded phrase or at least one pre-recorded word recognized by a phrase recognition module.

15. A method for operating a wearable camera activated security accessory, comprising:
(a) detecting motion of a person proximal to a wearer of the security accessory by a motion sensor;
(b) activating a camera module in response to the motion sensor detecting the motion, in order for the camera module to capture images of a face of the person proximal to the wearer of said security accessory;
(c) storing said captured images as facial information of said person proximal to the wearer;
(d) obtain current location information of said security accessory via a Global Positioning System (GPS) module of the security accessory;
(e) sending facial information and current location information to a remote server, in order to create a log pertaining to motion sensed by the motion sensor.

16. The method of claim 15, wherein only authorized personnel are able to access said log pertaining to motion sensed by the motion sensor.

17. The method of claim 15, wherein the motion sensor is activated in response to a panic button being pressed by the wearer of said security accessory.

18. The method of claim 15, wherein the motion sensor is activated in response to a tap by a wearer.

19. The method of claim 15, wherein the motion sensor is activated in response to a wearer's voice recognized by a voice recognition module.

20. The method of claim 15, wherein the motion sensor is activated in response to at least one pre-recorded phrase or at least one pre-recorded word recognized by a phrase recognition module.
